(19) United States
(12) Patent Application Publication
(10) Pub. No.: US 2011/0307800 A1
(43) Pub. Date: Dec. 15, 2011

(54) Methodology for Creating an Easy-To-Use Conference Room System Controller

(76) Inventors: Maribeth Joy Back, Woodside, CA (US); Gene Golovchinsky, Menlo Park, CA (US); John Steven Boreczky, San Leandro, CA (US); Anthony Eric Dunnigan, Berkeley, CA (US); Pernilla Qvarfordt, Los Altos, CA (US); William J. van Melle, Los Altos, CA (US); Laurent Denoue, Palo Alto, CA (US)

(21) Appl. No.: 13/217,133

(22) Filed: Aug. 24, 2011

Related U.S. Application Data
(63) Continuation of application No. 11/780,384, filed on Jul. 19, 2007.

(51) Int. Cl. G06F 3/01

(52) U.S. Cl. 715/745

(57) ABSTRACT

In embodiments, a user interface provides for manipulating one or more physical devices for use in a conference room setting. The user interface includes a touch screen for presenting a variety of options to a user. The touch screen includes controllers, such as buttons, to enable the user to select any one of the options. Each of the controllers has goals-oriented information, enabling the user to select a goal, while insulating the user from the underlying complex processes required to carry out the goal through the selection of one of the controllers.

### RELATED APPLICATIONS

This application is a continuation of U.S. patent application Ser. No. 11/780,384, filed Jul. 19, 2007, which application is incorporated by reference herein in its entirety. This application claims priority to U.S. Provisional Patent Application 60/887,110 filed Jan. 29, 2007, entitled “DESIGN AND DESIGN METHODOLOGY FOR CREATING AN EASY-TO-USE-CONFERENCE ROOM SYSTEM CONTROLLER,” which is hereby incorporated by reference.

### TECHNICAL FIELD

The present invention relates to user interfaces and computer systems architecture for conference room designs.

### BACKGROUND

Technology-rich environments such as conference rooms are often difficult to use because the various components in them do not interoperate cleanly, are often unaware of each other, and require separate control. It is difficult for casual users to coordinate the use of such devices to perform specific tasks, such as holding a teleconference.

Ubiquitous computing (“ubicomp”) is one methodology for providing a technology-rich environment such as a conference room. Ubicomp integrates computation into the environment, rather than having computers which are distinct objects. Other terms for ubicomp include pervasive computing, calm technology, “things that think,” and everyware. Ubicomp focuses on embedding computation into the environment and everyday objects to enable people to interact with information-processing devices more naturally and casually than they currently do, and in whatever location or circumstance they find themselves.

In a sense, however, ubicomp is an oxymoron. In particular, in “smart” conference rooms, applications of ubicomp technologies have generally been far from user-friendly. Current research in high-end room systems often focuses on a multiplicity of thin, bright display screens both large and small, along with interactive whiteboards, robotic cameras, and remote conferencing systems with rich media handling capabilities. Rich media is information that consists of any combination of graphics, audio, video and animation, which is more storage and bandwidth intensive than ordinary text. Exploiting all these technologies in one room, however, is a daunting task. Faced with three or more display screens, most presenters opt for simply replicating the same image on all the screens. Even more daunting is the design challenge of how to choose which room functions performed by machines are vital to particular tasks that different users want to perform, which room functions are vital to a particular room, and which room functions are well suited to a particular culture. For a particular room example, a room function of teleconferencing is more likely to be vital to a small conference room design than to a large conference room design. For an example regarding culture, designs might be different for conference rooms in the Japanese versus those in the United States. In Japan, business meetings are generally scripted and closely follow an agenda. These meetings might be followed by a brainstorming session. In the United States, however, business meetings are commonly brainstorming sessions. A Japanese conference room design might focus on PowerPoint slides, whereas a United States conference room design might focus on interactive whiteboards.

Maintenance is another issue. Nearly all smart rooms have resident staff who keep the room's systems functioning, and who often must be available on an everyday basis just to enable users to use the room. The systems in these rooms are designed for and assume the presence of these human “wizards.” These systems are seldom designed with users' activities in mind. In addition, users do not know what to expect in these rooms because there is no technology standard for next-generation conference rooms.

In general, it would be beneficial to provide improvements to conference room system designs. In particular, it would be beneficial to provide these improvements in smart room environments.

### SUMMARY

In embodiments, a user interface provides for manipulating one or more physical devices for use in a conference room setting. The user interface includes a touch screen for presenting a variety of options to a user. The touch screen includes controllers, such as buttons, to enable the user to select any one of the options. Each of the controllers has goals-oriented information, enabling the user to select a goal, while insulating the user from the underlying complex processes required to carry out the goal through the selection of one of the controllers.

### BRIEF DESCRIPTION OF THE DRAWINGS

Preferred embodiment(s) of the present invention will be described in detail based on the following figures, wherein:

FIG. 1 illustrates that a user interface can be adapted from one that is goal oriented to one that is process oriented, according to embodiments;

FIG. 2 is a photograph showing an example conference room having two display screens, according to embodiments;

FIG. 3 is a photograph showing an example conference room having an example Usable Smart Environment (“USE”) user interface (“UI”) on an example touch screen tablet PC as used with two example display screens, according to embodiments;

FIG. 4 is a UI screen shot showing an example starting screen, according to embodiments;

FIG. 5 is a UI screen shot showing example main menus of applications that can be run for an example two screens of the conference room shown in FIG. 3, according to embodiments.

FIG. 6 is a UI screen shot showing a user's example list of video conference attendees for the example Video Conference selected by the user in FIG. 5, according to embodiments;

FIG. 7 is a UI screen shot showing a user's example list of presentations for the example Presentation selected by the user in FIG. 6, according to embodiments;

FIG. 8 is a UI screen shot showing example presentation controls for an example presentation selected by the user in FIG. 7, according to embodiments;

FIG. 9 is a UI screen shot showing example video conference controls for an example conference meeting attendee selected by the user in FIG. 8, according to embodiments;

FIG. 10 is a UI screen shot showing example video conference controls and displays for the video conference set up in FIG. 9, according to embodiments;

FIG. 11 shows example UI screen shots and corresponding example photographs of conference room display screens, according to embodiments;

FIG. 12 is a UI screen shot showing an example of White Board selected by the user, according to embodiments;

FIG. 13 is a UI screen shot showing an example of Laptop selected by the user, according to embodiments; and

FIG. 14 illustrates various button states of the buttons shown in FIGS. 3-13, according to embodiments.

### DESCRIPTION OF EMBODIMENTS

In embodiments, the present invention provides for a user interface design for a conference room designed for ease of use in rooms with full next-generation functionality. In embodiments, a Usable Smart Environment (“USE”) system provides a flexible, extensible architecture specifically designed to enhance ease of use in smart environments, particularly conference rooms or classrooms. The USE system features an easy-to-use customized central control console. The console's design as well as the architecture of the underlying systems are based in cross-cultural ethnographic studies on the way people use conference rooms. The system allows customization and personalization of smart environments for particular people and groups, types of work, and specific physical spaces.

In embodiments, a focus of the USE system is that users enter conference rooms to create and maintain relations with each other, not necessarily to use the technology. This focus leads to the integration of separate pieces of technology to support the natural activities of people meeting in the room, without the added burden of making the technology work.

In embodiments, the USE system is based on a “wizard-free” conference room designed for ease of use, yet retaining next-generation functionality. USE includes a unique User Interface (“UI”) that interfaces multi-display systems, immersive conferencing with document support, digital whiteboard/annotation, and secure authentication. When scheduling a meeting, users can select predefined configurations, or modify them to suit the needs of the meeting by assigning applications to displays. The design of the user interface is detailed below.

In embodiments, the USE system coordinates the behavior of devices on behalf of a user based on configurations created for specific situations. For example, in a conference room setting, the system would coordinate the use of projectors, computer displays, and teleconferencing systems to support a video conference with shared documents. Unlike existing infrastructure, no dedicated remote control devices would be required to operate the entire system. Unlike other room control systems, this approach does not require the system software to be rebuilt to accommodate new devices.

In embodiments, the USE system strikes an effective balance between usability and new kinds of functionality. Examples of new kinds of functionality are multiple displays, new interfaces, rich media systems, new uploading/access/security systems, and robust mobile integration, meaning integration of mobile devices such as smart phones and laptop computers into meetings. As development in areas such as context-aware computing, interactive furniture, embedded systems, and mobile devices is occurring, users expect to find the adaptable ease of use that they get from their personal devices in all the technology they encounter, in particular in smart environments.

### USE Console User Interface

### Description

In embodiments, the UI allows for the manipulation of several physical devices from one touch screen or other mobile computing device. The UI is a graphical interface that can communicate with a conference room controller via a web service that acts as a bridge between the UI and controller. All communication to and from the web service bridge can be handled via an XML socket connection.

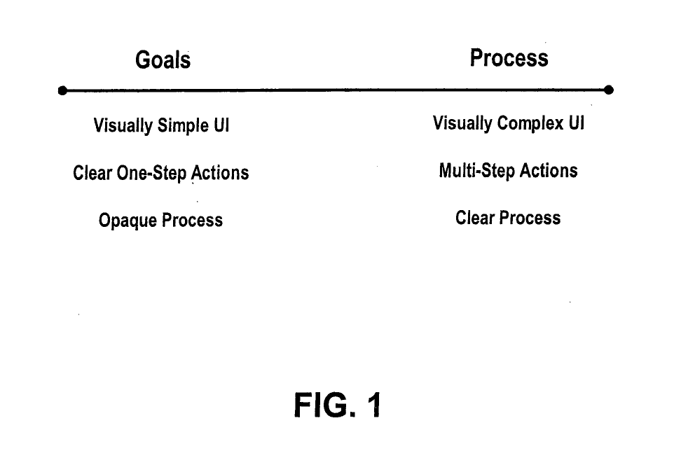

FIG. 1 illustrates that a user interface can be adapted from one that is goal-oriented to one that is process-oriented, according to embodiments. The UI is adaptable to each particular user. FIG. 1 shows a continuum of goal-oriented to process-oriented, and all variations of the UI for the different users fit within this continuum. A user's place within this continuum is assigned as a ranking when the user registers with the system. This ranking may be updated as the user continues to use the system.

In its simplest form, the UI presents only potential end results to the user, for example, “call Tom,” or “present my PowerPoint file.” This goal-oriented form of the UI, as shown under Goals of FIG. 1, insulates the user from the complex processes that are necessary to carry out the user's requests. By presenting all options in a manner in which a goals-oriented user is comfortable, this type of particular user will trust the system. This allows the user to focus on his/her tasks, not on using the UI. For example, this goal-oriented form of the UI would likely be used by a business executive, such as a Chief Executive Officer. Thus, as shown in FIG. 1 under Goals, a goal-oriented form of the UI is for a user who wants a Visually Simple UI and Clear One-Step Actions, so the user can focus on his/her tasks, as well as an Opaque Process, so the user is insulated from complex processes to carry out the user's requests.

Many users do not trust a system that hides too much of the process from the user. These users can then be presented with a more detailed, process-oriented UI, as shown under Process of FIG. 1. The UI therefore reveals much more about the underlying system to the user and allows for finer user controls. This level of detail can confuse many users. Thus, at a certain point, adding complexity to the UI becomes impractical for the user. Once the UI begins to represent the functionality of any device controller in a 1:1 manner, using the UI begins to resemble using the original control. Thus, as shown in FIG. 1 under Process, a process-oriented form of the UI is for the user who wants a Visually Complex UI, Multi-Step Actions, and a Clear Process to allow the user finer user controls.

### Design Considerations

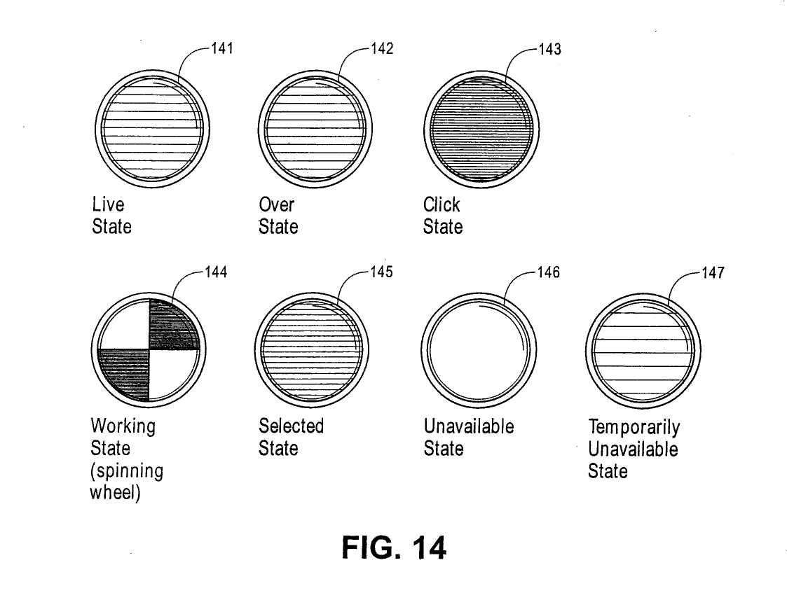

Some of the conference room devices in the room can take a few seconds to react to a user's input. In embodiments, the UI can slow down the user a bit by slowing down any animations or transitions in the UI. In embodiments, even objects like buttons, as shown in FIG. 14, can have slower than normal animation cycles.

In embodiments, the UI can run on a touch screen tablet PC. Alternatively, the UI can run on any type of computer or laptop. Instead of a touch screen, any type of pointing device can be used with a regular computer screen. As already indicated, however, one of the goals of the UI is to provide a non-computer-like interface for the user. To the user, the particular console having the UI is simply a tool for controlling the user's meeting, not a computer. If the user regards the console as a computer and exits the UI in order to check his or her email or surf the web, the user loses control of the room.

In embodiments, the UI elements the UI features are clearly labeled virtual buttons. The buttons are round and triangle shaped for ease of use. Further, the buttons are shown in primary colors of green, red, and yellow, also for ease of use. In embodiments, any of the buttons can be of any shape, size, and color. In embodiments, one or more of the buttons can instead be any type of controller, such as a slider.

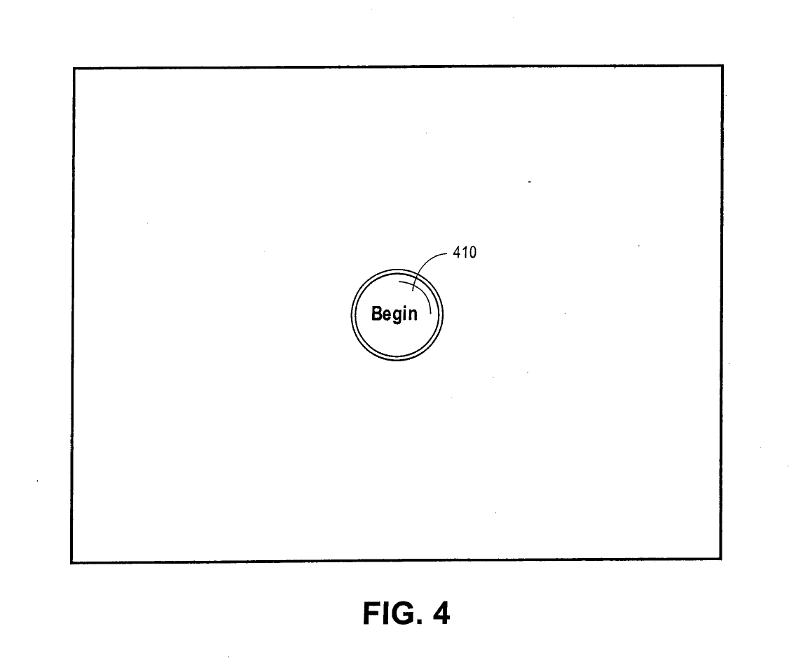

This UI design is quite comfortable to use, as there is little need to interpret the meaning of the information that is being displayed on the screen. The example FIGS. 4-14 show screen shots that capture the simpler, goal-oriented UI embodiment of the control console. In embodiments, the UI features any combination of UI elements, such as toolbars, palettes, and clearly labeled buttons.

### Design Details

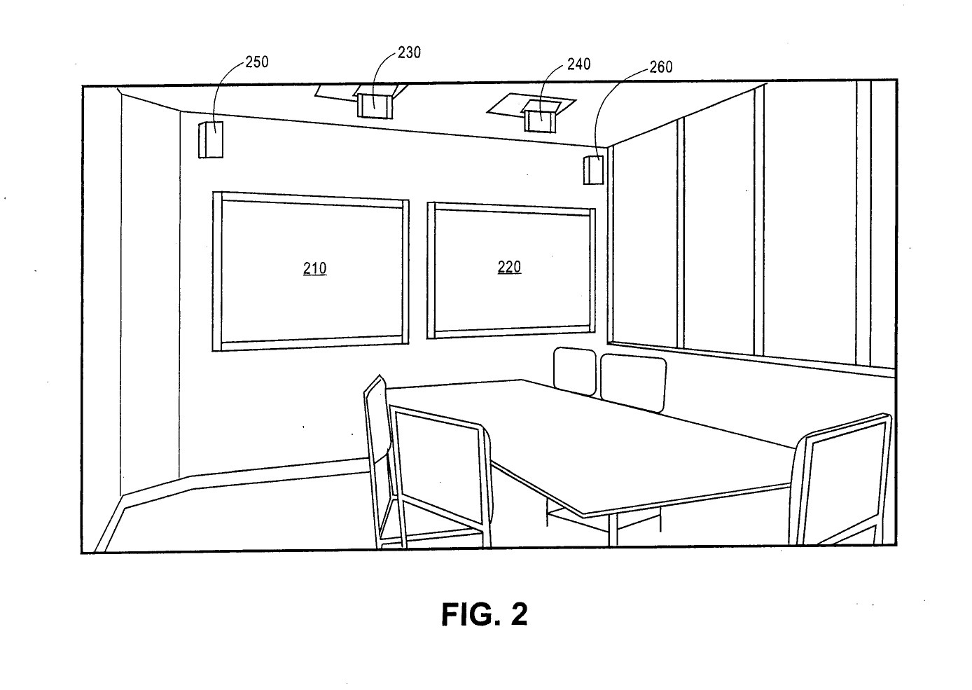

FIG. 2 is a photograph showing an example conference room having two display screens 210 and 220, according to embodiments. The two display screens 210 and 220 shown on the far wall in FIG. 2 can be in any location in the room. In embodiments, any number of display screens in any configuration can be used with the USE UI. FIG. 2 also shows two projectors 230 and 240 extending down from the ceiling for projecting displays from different applications to the display screens. Two speakers 250 and 260 are also shown on the far wall in FIG. 2 used for teleconferencing or other application purposes.

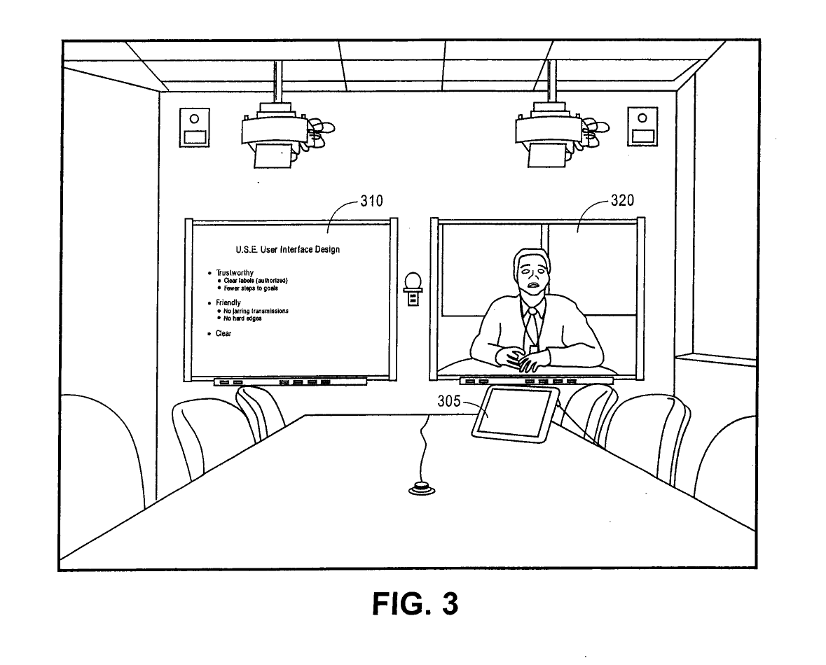

FIG. 3 is a photograph showing an example conference room having an example USE UI on an example touch screen tablet PC 305 as used with two example display screens 310 and 320, according to embodiments. This conference room is set up in a similar manner as the room shown in FIG. 2. Although a user is not shown sitting at the table, a video conference meeting is in progress. Generally a user and any number of other people would be in the conference room. The user that called a meeting uses the touch screen tablet PC 305 on the table to call and control the meeting, as discussed in more detail below. In this example, a PowerPoint presentation is also part of the video conference meeting. Shown on the left display screen 310 is one slide of a PowerPoint presentation. Shown on the right display screen 320 is a video conference attendee who is in a remote location, whether in another conference room of the same building or elsewhere. The discussion related to FIGS. 4-14 includes references to elements shown in FIG. 3.

FIG. 4 is a UI screen shot showing an example starting screen, according to embodiments. When a user enters the conference room to call a meeting, the user will find this screen on the UI touch screen, for example the touch screen of the tablet PC 305. In embodiments, a standalone Radio Frequency Identification (RFID) Smart Card device (not shown) is connected to USE via USB, and is located on the table next to the touch screen table PC 305. In embodiments, the user swipes his or her Smart Card through the RFID Smart Card device for identification purposes, discussed in more detail below. Shown in the middle of the UI touch screen is a Begin button 410, and the user simply touches the button to start USE. Once a user decides to end the meeting using the UI touch screen, the USE system returns to this screen.

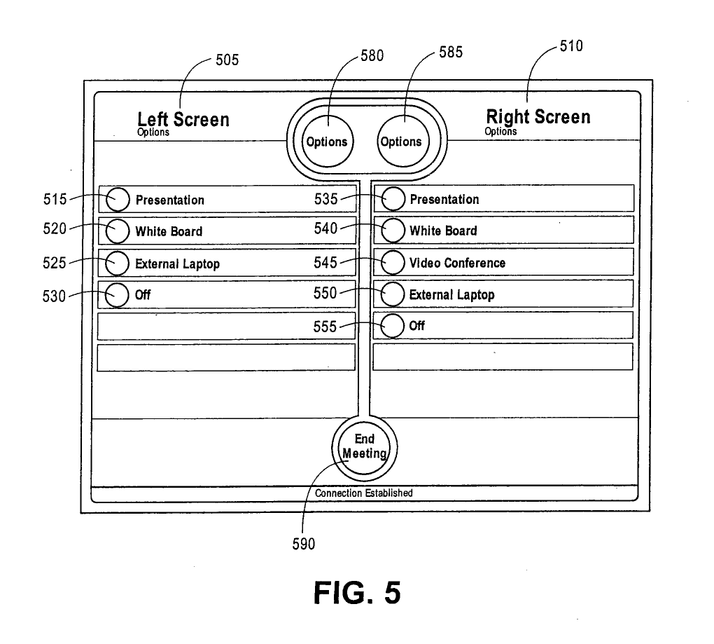

FIG. 5 is a UI screen shot showing example main menus of applications that can be run for an example two screens of the conference room shown in FIG. 3, according to embodiments. This screen is divided into a left half and a right half because the conference room shown in FIG. 3 has two display screens. In FIG. 5, the left half of the screen is labeled Left Screen Options 505 and controls applications that can be run on the left display screen 310 of FIG. 3. The right half of the screen in FIG. 5 is labeled Right Screen Options 510 and controls applications that can be run on the right display screen 320 of FIG. 3. The types of applications that can be run on different display screens can vary because the display screen capabilities can vary. Examples of applications that can be run and displayed to display screens are PowerPoint, which are PowerPoint presentations, White Board, which are interactive whiteboards with an electronic marker that allows writing on an electronic whiteboard, and External Laptops, which are laptops in addition to the UI console, whether or not the UI console is a laptop. Employees or guests might bring these external laptops into the meeting with them.

Before a user begins a meeting with the USE UI, applications that can be used with a particular screen are programmed into USE. Further, information about each user is programmed into USE, and each user has an associated identification number (“ID”). For example, suppose a user plans to incorporate one or more PowerPoint presentations into a conference. The user's files containing presentations are preloaded into USE and identified by the user's ID. In another example, possible meeting attendees' information are preloaded into USE and associated with the user's ID. Information for an attendee includes attendee's name and contact information, such as a telephone number. If the user swipes his or her RFID Smart Card through the device on the touch screen and the user is authenticated to use the system, information associated with the user's ID already programmed into USE is then available to the user during the user's current USE session.

Although the example FIG. 5 shows only two screens, in embodiments, USE can handle any number of screens. To handle three or more screens, the user interface of FIG. 5 is tileable. USE can configure itself, depending on how many screens need to be handled simultaneously. Thus, for three or more screens, the main menus of FIG. 5 can be shown as tiles that are squared up to each other in row and column order. Instead of two screen labels 505 and 510, additional screen labels would be needed for multiple screens. Example screen labels for multiple screens could be Screen 1, Screen 2, Screen 3, . . . , Screen N, where N is the number of screens.

In embodiments, additional applications can be embedded in the USE controller to support the applications in the main menus of FIG. 5. These additional applications can allow the use of external pieces of hardware. For example, multiple screen handling applications, such as those that use Explicitly Parallel Instruction Computing (“EPIC”), can be used with USE to perform the background functions of multiple screen handling. Another example is an application that can support High Definition (“HiDef') conferencing. Another example is an application that allows the user to view three-dimensional (”3D″) PowerPoint presentations. Another example is an application that can handle the use of mobile phones in conferencing.

In FIG. 5, applications that can be shown on the left display screen 310 of FIG. 3 are listed as buttons that the user can select. These example buttons are Presentation button 515, White Board button 520, and External Laptop button 525. If a user wants to turn off the left display screen 310 of FIG. 3 and only use the right display screen 320, the user can select the Off button 530. In FIG. 5, applications that can be shown on the right display screen 320 of FIG. 3 are listed as buttons that the user can select. These example buttons are Presentation button 535, White Board button 540, Video Conference button 545, and External Laptop button 550. If a user wants to turn off the right display screen 320 of FIG. 3 and only use the left display screen 310, the user can select the Off button 555.

On any of the screens shown in FIGS. 5-13, if the user selects the Options button 580, USE shows the main menu of available applications shown in the left half of the screen in FIG. 5, which are the applications available for the left display screen 310 of FIG. 3. Similarly, on any of the screens shown in FIGS. 5-13, if the user selects the Options button 585, USE shows the main menu of available applications shown in the right half of the screen in FIG. 5, which are the applications available for the right display screen 320 of FIG. 3. Further, on any of the screens shown in FIGS. 5-13, the user can end the conference at any time by selecting the End Meeting button 590.

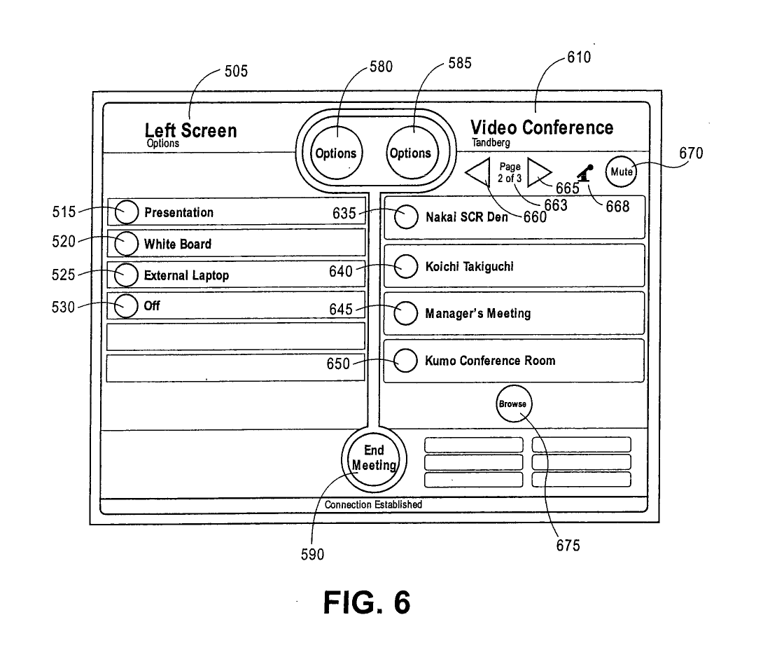

FIG. 6 is a UI screen shot showing a user's example list of video conference attendees for the example Video Conference selected by the user in FIG. 5, according to embodiments. In this example, from the Right Screen 510 of FIG. 5, the user selects the Video Conference button 545, which then takes the user to the UI screen shot of FIG. 6. The right half of the screen in FIG. 6 is now labeled Video Conference 610. The brand name of the video conferencing system, such as Tandberg, for the Tandberg Device Library, can be displayed on the screen just beneath Video Conference 610, for example.

Below Video Conference 610 is a list of those conference meeting attendees with whom the user normally meets. This list of likely attendees is linked to the user's identification number in USE. A telephone number is stored with each attendee's name. In embodiments, other forms of contact can be used besides or in addition to a telephone number. The attendee's name can also be the location of attendee(s), such as a conference room or other room. The user can enter likely attendee information into USE prior to the time the user begins the conference meeting with the USE UI. Alternatively, a user can be given system permission to enter likely attendee information for another user. For example, an administrative assistant can enter an executive's likely attendee contact information prior to the time the executive begins the conference meeting with the USE UI.

In FIG. 6, an example list of likely attendees shows names of three rooms and one attendee's name, Nakai SCR Den, Koichi Takiguchi, Manager's Meeting, and Kumo Conference Room. The user selects an attendee by selecting the corresponding button. For example, the user can select one of the three rooms, Nakai SCR Den button 635, Manager's Meeting button 645, and Kumo Conference Room button 650. One or more attendees can gather in these rooms to participate in the conference meeting. The user can also select attendee Koichi Takiguchi button 640. Possible attendee Koichi is presumably located at his own telephone number, such as in his office, for example. Other meeting attendees could also participate in the conference meeting with Koichi at his location. The user can page through the list of likely attendees using the left arrow button 660 and right arrow button 665. Shown between the two arrow buttons 660 and 665 is the current page of the total number of pages of likely attendees. Page indicator 663 shows that the user is viewing the second page of three pages of likely attendees, or “Page 2 of 3.”

Should the user want to browse other contacts to possibly include in the conference meeting, the user can select Browse button 675, which brings up another screen (not shown) with the user's list of contacts for selection to include in the conference meeting and that also allows the user to enter a telephone number.

Microphone icon 668 shows whether audio to all other meeting attendees is on or off. When the microphone is on, microphone icon 668 is shown as in FIG. 6. When the microphone is off, microphone icon 668 is shown as a microphone with a circle around it and a slash through the circle. Microphone button 670 enables the user to mute or unmute the microphone at any time.

The Left Screen 505, as well as application buttons 515, 520, 525, and Off button 530, is the same in FIG. 6 as in FIG. 5. If the user selects the Options button 580, USE shows the main menu of available applications shown in the left half of the screen in FIG. 5, which are the applications available for the left display screen 310 of FIG. 3. If the user selects the Options button 585, USE shows the main menu of available applications shown in the right half of the screen in FIG. 5, which are the applications available for the right display screen 320 of FIG. 3. Further, the user can end the conference at any time by selecting the End Meeting button 590.

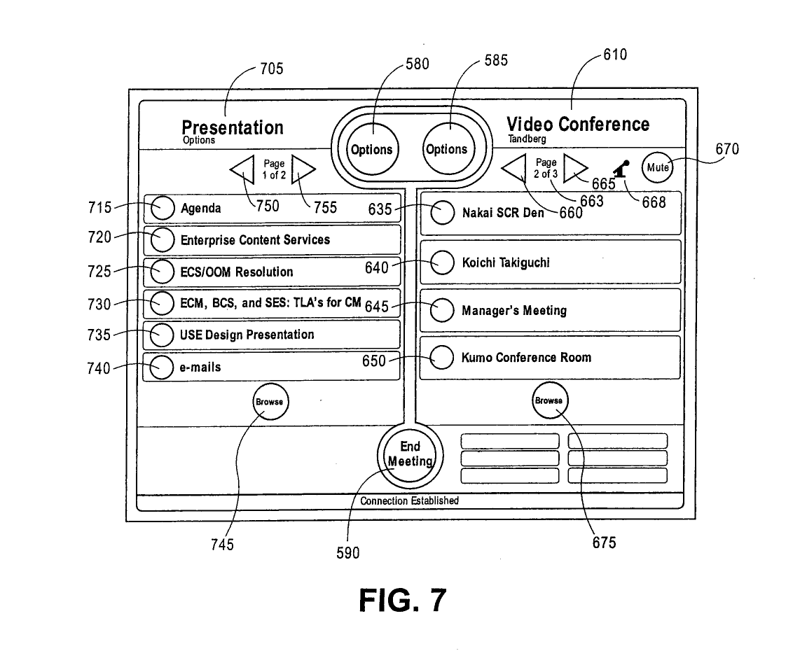

FIG. 7 is a UI screen shot showing a user's example list of presentations for the example Presentation selected by the user in FIG. 6, according to embodiments. In this example, from the Left Screen 505 of FIG. 6, the user selects the Presentation button 515, which then takes the user to the UI screen shot of FIG. 7. The left half of the screen in FIG. 7 is now labeled Presentation 705.

Below Presentation 705 is a list of the user's presentations to which the user might refer during the video conference meeting. This list of presentations is linked to the user's identification number in USE. These presentations can be PowerPoint presentations or other types of presentations. The user can enter the filenames of these presentations into USE prior to the time the user begins the conference meeting with the USE UI. Alternatively, a user can be given system permission to enter presentation filenames for another user. For example, an administrative assistant can enter an executive's presentation filenames prior to the time the executive begins the conference meeting with the USE UI.

In FIG. 7, an example list of presentations is Agenda, Enterprise Content Services, ECS/OOM Resolution, “ECM, BCS, and SES: TLA's for CM,” and USE Design Presentation. The user selects an attendee by selecting the corresponding button. For example, the user can select one of Agenda button 715, Enterprise Content Services button 720, ECS/OOM Resolution button 725, ECM, BCS, and SES: TLA's for CM button 730, and USE Design Presentation button 735. Selecting the e-mails button 740 brings up another screen (not shown) to enable the user to call up and read the user's e-mails as part of the conference meeting. The user can page through the list of presentations using the left arrow button 750 and right arrow button 755. Shown between the two arrow buttons 750 and 755 is the current page of the total number of pages of presentations. This example shows that the user is viewing the first page of two pages of presentations, or “Page 1 of 2.” Left arrow button 750 is dimmed to show that the user can not select any pages prior to the first page. Similarly, if the user was viewing the last page of presentations, the right arrow button 755 would be dimmed to show that the user can not select any pages after the last page.

Should the user want to browse other presentations to possibly include in the conference meeting, the user can select Browse button 745, which brings up another screen (not shown) with an additional list of the user's presentations for selection to include in the conference meeting. The screen also allows the user to browse for the filename of a presentation not previously loaded into USE but accessible by the USE system, for example a presentation located on a networked filesystem.

The Video Conference 610 half of the screen is the same in FIG. 7 as in FIG. 6, including attendee buttons 635, 640, 645, and 650, page arrow buttons 660 and 665, page indicator 663, microphone icon 668, microphone button 670, and Browse button 675. If the user selects the Options button 580, USE shows the main menu of available applications shown in the left half of the screen in FIG. 5, which are the applications available for the left display screen 310 of FIG. 3. If the user selects the Options button 585, USE shows the main menu of available applications shown in the right half of the screen in FIG. 5, which are the applications available for the right display screen 320 of FIG. 3. Further, the user can end the conference at any time by selecting the End Meeting button 590.

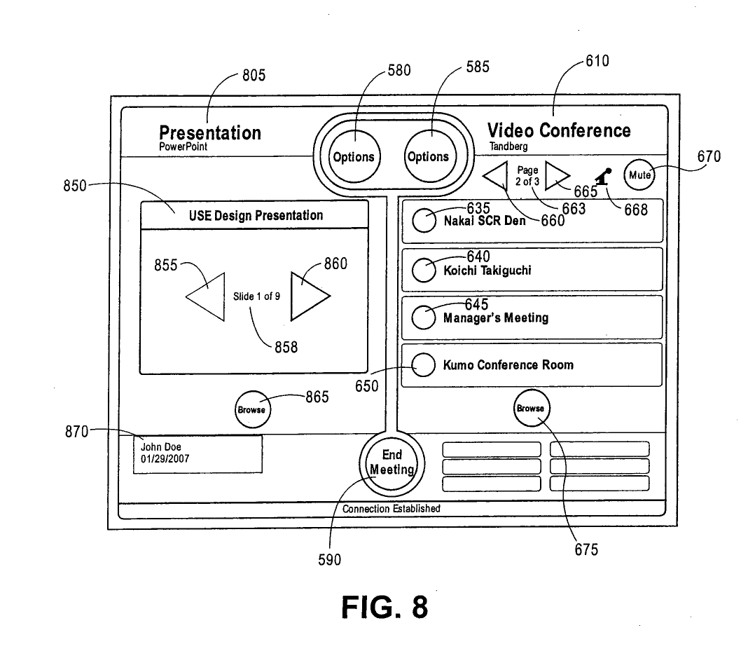

FIG. 8 is a UI screen shot showing example presentation controls for an example presentation selected by the user in FIG. 7, according to embodiments. In this example, from the left side of the screen under Presentation 705 of FIG. 7, the user selects the USE Design Presentation button 735, which then takes the user to the UI screen shot of FIG. 8. The left half of the screen in FIG. 8 is now labeled Presentation 805. The brand name of the presentation, such as PowerPoint, can be displayed on the screen, just beneath Presentation 805, for example. In this example, the USE Design Presentation is a PowerPoint presentation, and PowerPoint is displayed on the screen, just beneath Presentation 805.

Below Presentation 805 is an area labeled USE Design Presentation 850. The user currently conducting the conference meeting, as well as the date of the conference meeting, can be shown on the screen, for example, John Doe and “01/29/2007” 870. The user's USE Design Presentation, previously loaded into the USE system as discussed above, is displayed to the left display screen 310 shown in FIG. 3. While John Doe references the display of the presentation on the left display screen 310 of FIG. 3, he can page through the slides of the presentation using the left arrow button 855 and right arrow button 860. Shown between the two arrow buttons 855 and 860 is the current slide of the total number of slides in the presentation. By default, the presentation begins by a display of the first presentation slide. This example slide indicator 858 shows that John Doe is viewing the first slide of nine slides of the presentation, or “Slide 1 of 9.” Left arrow button 855 is dimmed to show that no slides exist prior to the first slide for John to select. Similarly, if John was viewing the last slide of the presentation, the right arrow button 860 would be dimmed to show that no slides exist after the last slide for him to select.

Should John Doe want to switch to a different presentation, he can select List button 865, which brings up another screen (not shown) similar to FIG. 7 with the list of his presentations other than the USE Design Presentation, or presentations 715, 720, 725, 730, as well as e-mails 740. John can select one or more presentations for use in the conference meeting. He can also search for the filename of a presentation not previously loaded into USE but accessible by the USE system, for example a presentation residing on a networked filesystem. In embodiments, the system remembers where the user was in each presentation. John could toggle between multiple presentations that he has opened by selecting List button 865, which brings up the list of presentations. In embodiments, a toggle button (not shown) can also be displayed to the screen to enable John to toggle between presentations he has opened.

The Video Conference 610 half of the screen is the same in FIG. 8 as in FIG. 6, including attendee buttons 635, 640, 645, and 650, page arrow buttons 660 and 665, page indicator 663, microphone icon 668, microphone button 670, and Browse button 675. If the user selects the Options button 580, USE shows the main menu of available applications shown in the left half of the screen in FIG. 5, which are the applications available for the left display screen 310 of FIG. 3. If the user selects the Options button 585, USE shows the main menu of available applications shown in the right half of the screen in FIG. 5, which are the applications available for the right display screen 320 of FIG. 3. Further, the user can end the conference at any time by selecting the End Meeting button 590.

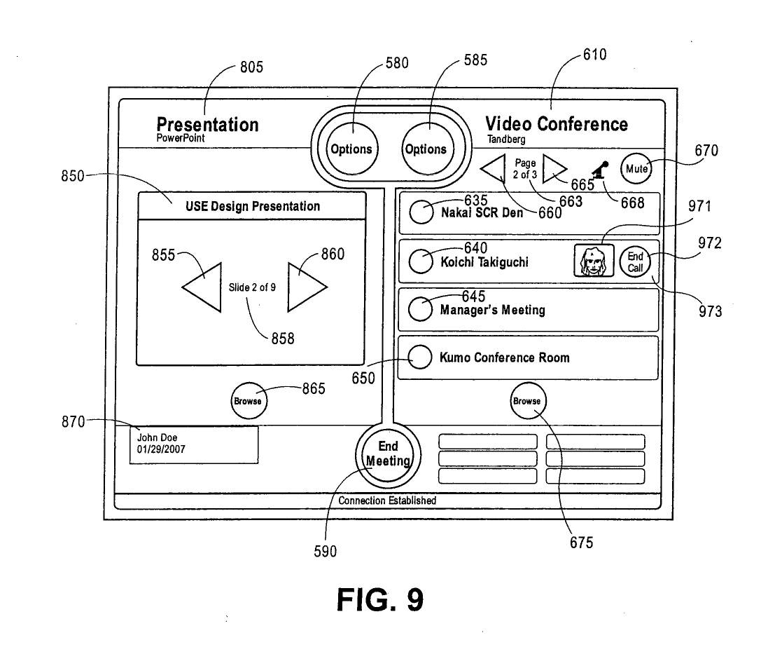

FIG. 9 is a UI screen shot showing example video conference controls for an example conference meeting attendee selected by the user in FIG. 8, according to embodiments. In this example, from the right side of the screen under Video Conference 610 of FIG. 8, user John Doe selects the Koichi Takiguchi button 640, which initiates a sequence of command events in the teleconferencing system, for example the Tandberg teleconferencing system, that would be required to call Koichi via the teleconferencing system. Once John establishes contact with Koichi, and Koichi agrees to attend the video conference meeting, John Doe is then taken to the UI screen shot of FIG. 9. Koichi's picture 971 can also be shown on the UI screen next to the Koichi Takiguchi button 640 to show that Koichi is one of the current attendees participating in the video conference meeting. John Doe can select as many attendees as he likes to attend the meeting. He simply initiates contact with any of the attendees in his list by scrolling through pages of attendees using arrow buttons 660 and 665, browsing additional attendees with Browse button 675, and by selecting attendee/room buttons such as 635, 645, and 650. In this example, the microphone remains unmuted, as shown by microphone icon 668. John can select microphone button 670 at any time to mute the microphone.

If Koichi Takiguchi is the only person at a remote location participating in the video conference meeting, then a real-time video of Koichi is shown to the right display screen 320 in FIG. 3. If two or more people, at remote locations to the conference room, are participating, the right display screen 320 in FIG. 3 is divided into tiles in order to display real-time videos of everyone at remote locations attending the meeting. If the remote location “attendee” is a room of people, such as the Kumo Conference Room selection 650 in FIG. 9, then a real-time video of people in the room is displayed to the right display screen 320 of FIG. 3. The user's picture can also be shown on the screen as a participant in the video conference meeting. These video displays to the right display screen 320 of FIG. 3 are handled by the video conferencing software, such as Tandberg, pre-loaded into USE.

An End Call button 972 can be selected by John Doe to end the telephone connection with Koichi should John decide that Koichi is leaving the meeting before the meeting ends. This End Call button 972 is more likely to be used in the case where two or more attendees are participating in the meeting. In the case where an attendee decides to leave the video conference meeting by hanging up the telephone, the attendee's picture 971 and corresponding End Call button 972 disappears from the screen.

The Presentation 805 half of the screen is the same in FIG. 9 as in FIG. 8, including presentation area labeled USE Design Presentation 850, slide arrow buttons 855 and 860, slide indicator 858, List button 865, and user and date, John Doe and “01/29/2007” 870. The only difference in the Presentation 805 half of the screen in FIG. 9 is that John Doe has selected the right arrow button to advance the presentation to slide two, and slide indicator 858 now shows “Slide 2 of 9.” Left slide arrow button 855 is now undimmed in FIG. 9.

If the user selects the Options button 580, USE shows the main menu of available applications shown in the left half of the screen in FIG. 5, which are the applications available for the left display screen 310 of FIG. 3. If the user selects the Options button 585, USE shows the main menu of available applications shown in the right half of the screen in FIG. 5, which are the applications available for the right display screen 320 of FIG. 3. Further, the user can end the conference at any time by selecting the End Meeting button 590.

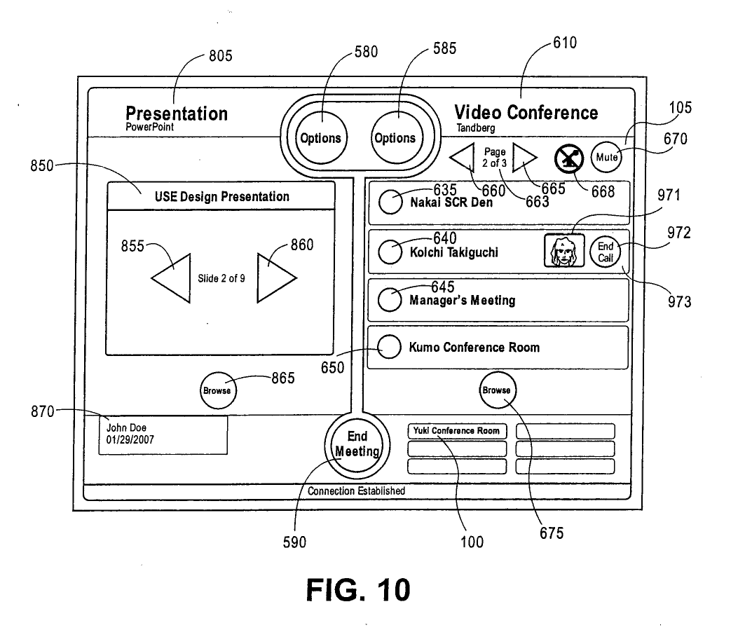

FIG. 10 is a UI screen shot showing example video conference controls and displays for the video conference set up in FIG. 9, according to embodiments. User John Doe has established contact with all attendees for his video conference meeting. His meeting includes only himself and anyone in the room with him, as well as Koichi Takiguchi. In this example, John selects the microphone button 670 to mute the audio to meeting attendees in remote locations. This enables him to have an off-line discussion with attendees in the room with him, for example. Microphone icon 668 is now shown as a microphone with a circle around it and with a slash through the circle. Button 670 is now shown as Unmute. Area 105 is shown can be shown in a different color, such as red, to remind the user that the microphone is muted. Further, a list of attendee locations can be displayed to the screen. In this example, Koichi Takiguchi is shown to be located in the Yuki Conference Room 100.

The other elements of the Video Conference 610 half of the screen are the same in FIG. 10 as in FIG. 6, including attendee buttons 635, 640, 645, and 650, page arrow buttons 660 and 665, page indicator 663, microphone icon 668, microphone button 670, and Browse button 675. If the user selects the Options button 580, USE shows the main menu of available applications shown in the left half of the screen in FIG. 5, which are the applications available for the left display screen 310 of FIG. 3. If the user selects the Options button 585, USE shows the main menu of available applications shown in the right half of the screen in FIG. 5, which are the applications available for the right display screen 320 of FIG. 3. Further, the user can end the conference at any time by selecting the End Meeting button 590.

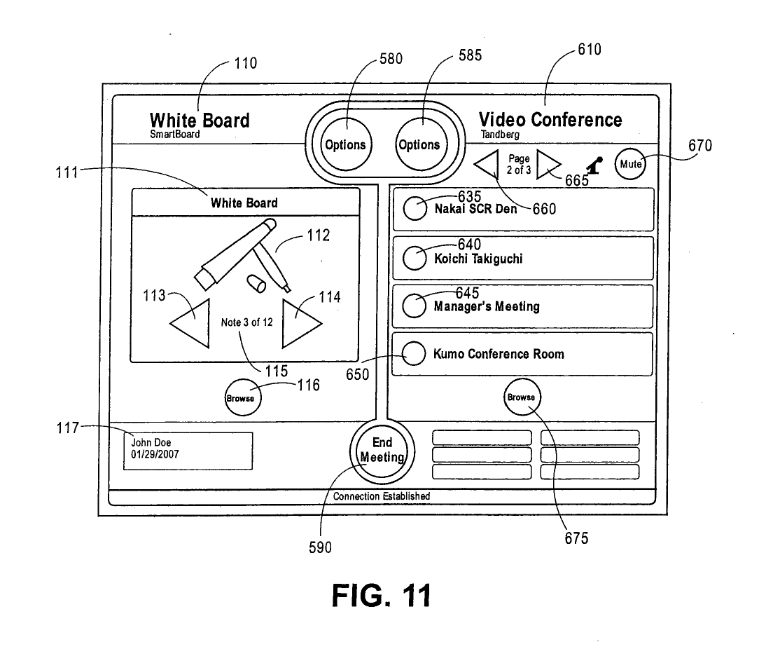

FIG. 11 is a UI screen shot showing an example of White Board selected by the user, according to embodiments. In this example, if the use selects the Options button 580 in FIG. 10, the user is taken to the UI screen shot shown in FIG. 6. From the Left Screen 505 of FIG. 6, the user selects the White Board button 520, which then takes the user to the UI screen shot of FIG. 11. The left half of the screen in FIG. 11 is now labeled White Board 110. The brand name of the whiteboard, such as SmartBoard, can be displayed on the screen just beneath White Board 110, for example.

Below White Board 110 is an area labeled White Board 111. Within this area is a markers/pens image 112 can be displayed to show to the user that the whiteboard is in use. The user currently conducting the conference meeting, as well as the date of the conference meeting, can be shown on the screen, for example, John Doe and “01/29/2007” 117. The whiteboard software, previously loaded on the USE system, displays an electronic whiteboard to the left display screen 310 shown in FIG. 3. The whiteboard software enables John to start with a blank whiteboard and draw on it. The whiteboard software also enables John to pull up notes from a saved whiteboard session and continue to draw on it. In embodiments, drawing tools for the whiteboard software would appear on the whiteboard screen, not on the console UI.

In this example, John pulled up twelve pages of previously saved notes. Just after he selected White Board 520 in FIG. 6 and just prior to being brought to FIG. 11, a screen (not shown) is displayed of available sets of whiteboard notes from which John can select. The screen would look similar to the presentations listed in FIG. 7, except that a list of whiteboard note sets would be displayed. Assuming John selects a set of twelve pages of notes from the screen. John is then taken to the screen shot of FIG. 11.

While John Doe references the display of the whiteboard on the left display screen 310 of FIG. 3, he can page through the notes using the left arrow button 113 and right arrow button 114. Shown between the two arrow buttons 113 and 114 is the current note of the total number of notes. By default, the whiteboard software displays the first note. The example note indicator 115 shows that John Doe is viewing the third note of twelve notes, or “Note 3 of 12.”

Should John Doe want to switch to a different set of whiteboard notes, he can select Browse button 116, which brings up another screen (not shown) with the list of other sets of saved notes. John can select one or more sets of notes for use in the conference meeting. He can also search for the filename of notes not previously loaded into USE but accessible by the USE system, for example notes residing on a networked filesystem. In embodiments, the system remembers where the user was in each set of whiteboard notes. John could toggle between sets of whiteboard notes he has opened by selecting Browse button 116, which brings up the list of sets of notes. In embodiments, a toggle button (not shown) can also be displayed to the screen to enable John to toggle between sets of notes he has opened.

In embodiments, the system remembers where the user was in each presentation and each set of whiteboard notes. If the user selects the Options button 580, USE shows the main menu of available applications shown in the left half of the screen in FIG. 5, which are the applications available for the left display screen 310 of FIG. 3. In embodiments, if the user selects Presentation 515, then Use Design Presentation 735, as shown in FIG. 7, the system takes the user to the point where he or she was in the presentation, as shown in FIG. 10. Alternatively, a button (not shown) could be provided on the screen of FIG. 11 that could take the user to a menu screen showing menu items of presentations and sets of whiteboard notes currently in use. The user could then select one of these menu items, and the system could take the user directly to the point where he or she was in the presentation or notes, such as the presentation shown in FIG. 10.

The Video Conference 610 half of the screen is the same in FIG. 11 as in FIG. 6, including attendee buttons 635, 640, 645, and 650, page arrow buttons 660 and 665, page indicator 663, microphone icon 668, microphone button 670, and Browse button 675. If the user selects the Options button 585, USE shows the main menu of available applications shown in the right half of the screen in FIG. 5, which are the applications available for the right display screen 320 of FIG. 3. Further, the user can end the conference at any time by selecting the End Meeting button 590.

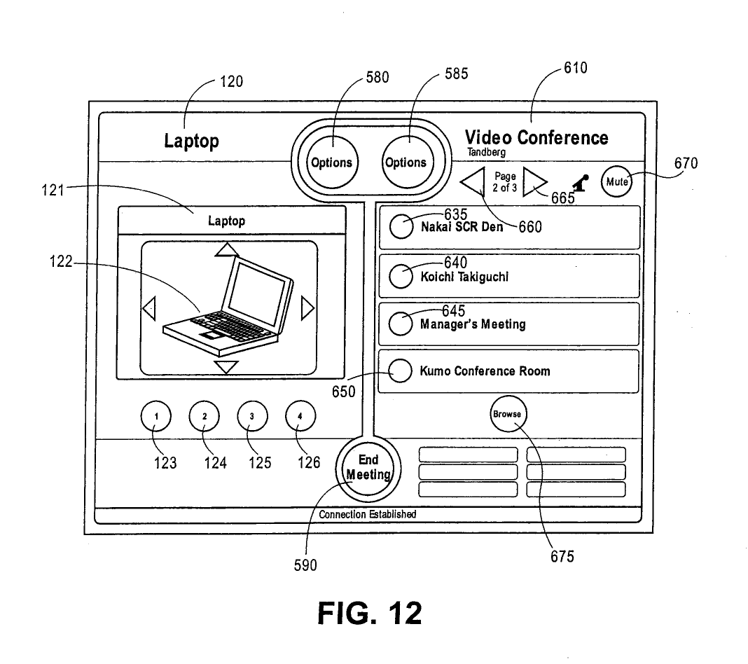

FIG. 12 is a UI screen shot showing an example of Laptop selected by the user, according to embodiments. In this example, if the user selects the Options button 580 in FIG. 11, the user is taken to the UI screen shot shown in FIG. 6. From the Left Screen 505 of FIG. 6, the user selects the External Laptop button 525, which then takes the user to the UI screen shot of FIG. 12. The left half of the screen in FIG. 12 is now labeled Laptop 120.

Below Laptop 120 is an area labeled Laptop 121. Within this area is a laptop image 122 that can be displayed to show to the user that a laptop display is being displayed to the left display screen 310 of FIG. 3. The user can select from a number of laptops. In this example, the user can select from any of four laptops by selecting any of buttons 123, 124, 125, and 126. In this example, the laptop corresponding to button 124 has been selected. The laptop display, as viewed on the laptop, is displayed to the left display screen 310 of FIG. 3. Presumably the user is using this laptop and wants to show items on his laptop to others attending the video conference meeting. The user currently conducting the conference meeting, as well as the date of the conference meeting can also be shown on the screen of FIG. 12.

Should John Doe want to switch to a different laptop than the laptop corresponding to button 124, he can select any of the other buttons 123, 125, and 126. In embodiments, the system remembers where the user was in each laptop. John could toggle between laptops he is using by selecting any button 123, 124, 125, and 126. In embodiments, a toggle button (not shown) can also be displayed to the screen to enable John to toggle between laptops he is using.

In embodiments, the system remembers where the user was in each presentation, each set of whiteboard notes, and each laptop session. If the user selects the Options button 580, USE shows the main menu of available applications shown in the left half of the screen in FIG. 5, which are the applications available for the left display screen 310 of FIG. 3. In embodiments, if the user selects Presentation 515, then Use Design Presentation 735, as shown in FIG. 7, the system takes the user to the point where he or she was in the presentation, as shown in FIG. 10. Alternatively, a button (not shown) could be provided on the screen of FIG. 11 that could take the user to a menu screen showing menu items of presentations, sets of whiteboard notes, and laptop sessions currently in use. The user could then select one these menu items, and the system could take the user directly to the point where he or she was in the presentation, notes, or laptop session, such as the presentation shown in FIG. 10.

The Video Conference 610 half of the screen is the same in FIG. 12 as in FIG. 6, including attendee buttons 635, 640, 645, and 650, page arrow buttons 660 and 665, page indicator 663, microphone icon 668, microphone button 670, and Browse button 675. If the user selects the Options button 585, USE shows the main menu of available applications shown in the right half of the screen in FIG. 5, which are the applications available for the right display screen 320 of FIG. 3. Further, the user can end the conference at any time by selecting the End Meeting button 590.

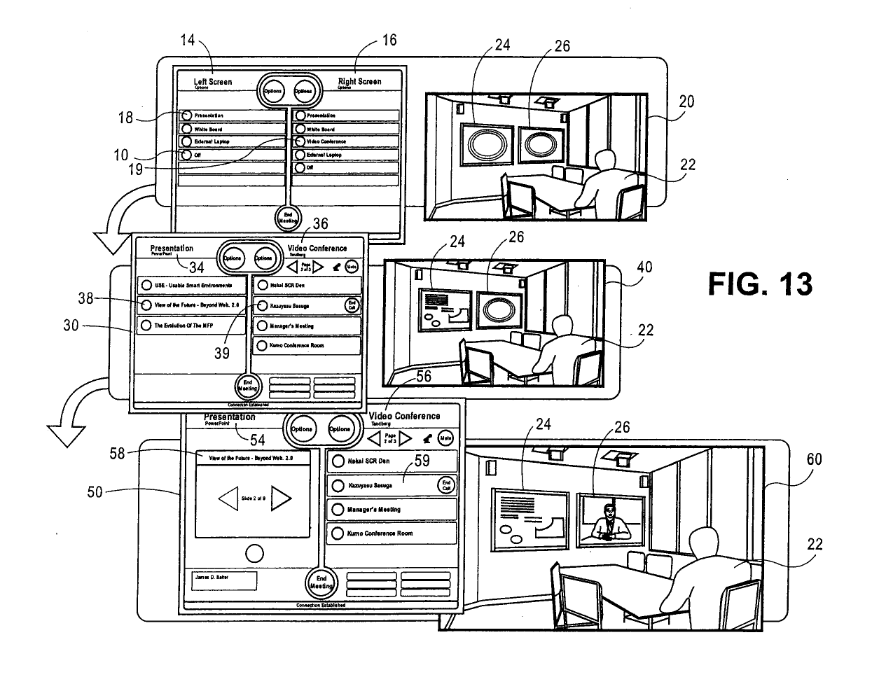

FIG. 13 shows example UI screen shots and corresponding example photographs of conference room display screens, according to embodiments. These UI screen shots are similar to those shown in FIGS. 5, 7, and 9, but some are not exact duplicates. These corresponding example photographs are similar to the photographs in FIGS. 2 and 3, but are not exact duplicates.

Screen shot 10 is the same as the screen shot of FIG. 5. The Left Screen 14 controls the right display screen 24 of conference room 20. The Right Screen 16 controls the left display screen 26 of conference room shown in photograph 20. Below Left Screen 14 is a list of available applications from which user 22 can select. Similarly, below Right Screen 16 is a list of available applications from which user 22 can select. At this point, because user 22 has not yet selected any applications, a USE logo can be displayed to screens 24 and 26 to show that USE is running but that applications have not yet been selected for display to these screens.

Screen shot 30 is similar to the screen shot of FIG. 7. From screen shot 10, the user 22 selected Presentation 18 from Left Screen 14 and Video Conference 19 from the Right Screen 16. The Presentation 34 side of screen shot 30 shows a list of the user's presentations. The Video Conference 36 side of the screen shot shows a list of the user's possible attendees. Assuming the user 22 selects presentation View of the Future—Beyond Web 2.0 button 38, a slide from this presentation is shown on left display screen 24 of the conference room in photograph 40. At this point, because user 22 has not yet selected attendees for the video conference, the USE logo remains displayed to the right screen 26 of the conference room in photograph 40.

Screen shot 50 is similar to the screen shot of FIG. 9. From screen shot 30, the user 22 selected presentation View of the Future—Beyond Web 2.0 button 38 from the Presentation 34 side of the screen shot and attendee Kazuyasu Sasuga 39 from the Video Conference 36 side of the screen shot. The Presentation 54 side of screen shot 50 shows an area 58 for controlling slides of the presentation View of the Future—Beyond Web 2.0. Slide 2 from this presentation is shown on the left display screen 24 of the conference room in photograph 60. The Video Conference 56 side of screen shot 50 shows that because Kazuyasu Sasuga 59 is highlighted, Kazuyasu is attending the video conference meeting. A real-time video of Kazuyasu is displayed to the right display screen 26 of the conference room in photograph 60.

FIG. 14 illustrates various button states of the buttons shown in FIGS. 4-13, according to embodiments. Live State button 141 indicates that the button is available for the user to select. If USE is used on a laptop or other device with a mouse, Over State button 142 indicates when the user moves the mouse over the button, at which point the user has not yet clicked on the button with the mouse. Similarly, for users using a mouse, Click State button 143 indicates that the user clicked on the button with the mouse to select the button. Working State button 144 indicates that USE is processing in the background, that the user should wait until it finishes processing, and that the user is not allowed to select any other buttons until it is finished processing. If the USE UI is used with a touch screen, Selected State button 145 indicates the user has selected the button by touching it on the touch screen. Selected State button 145 is similar to the Click State button 143 except that the user touches the button instead of clicking on the button with a mouse. Unavailable State button 146 indicates that the button is unavailable for the user to select. For example in FIG. 8, the Back triangle under Presentation is shown in the Unavailable State because page 1 of two pages of presentations is shown, and no previous pages exist. Temporarily Unavailable State button 147 indicates that the button is temporarily unavailable for the user to select. For example, an application in FIG. 5 can be temporarily unavailable if it is being upgraded to a new version.

The buttons shown in the figures are round and triangle shaped for ease of use. Further, the buttons are shown in primary colors of green, red, and yellow, also for ease of use. In embodiments, any of the buttons can be of any shape, size, and color. In embodiments, one or more of the buttons can instead be any type of controller, such as a slider.

### System Hardware, Software and Components

Embodiments of the present invention can include computer-based methods and systems which can be implemented using a conventional general purpose or a specialized digital computer(s) or microprocessor(s), programmed according to the teachings of the present disclosure. Appropriate software coding can readily be prepared by programmers based on the teachings of the present disclosure. Embodiments of the present invention can include a program of instructions executable by a computer to perform any of the features presented herein.

Embodiments of the present invention can include a computer readable medium, such as a computer readable storage medium. The computer readable storage medium can have stored instructions which can be used to program a computer to perform any of the features presented herein. The storage medium can include, but is not limited to, any type of disk including floppy disks, optical discs, DVDs, CD-ROMs, microdrives, and magneto-optical disks, ROMs, RAMs, EPROMs, EEPROMs, DRAMs, flash memory or any media or device suitable for storing instructions and/or data. The present invention can include software for controlling both the hardware of a computer, such as a general purpose/specialized computer(s) or microprocessor(s), and for enabling them to interact with a human user or other mechanism utilizing the results of the present invention. Such software may include, but is not limited to, device drivers, operating systems, execution environments/containers, user interfaces, and user applications.

Embodiments of the present invention can include providing code for implementing processes of the present invention. The providing can include providing code to a user in any manner. For example, the providing can include transmitting digital signals containing the code to a user; providing the code on a physical media to a user; or any other method of making the code available.

Embodiments of the present invention can include a computer implemented method for transmitting the code which can be executed at a computer to perform any of the processes of embodiments of the present invention. The transmitting can include transfer through any portion of a network, such as the Internet; through wires, the atmosphere or space; or any other type of transmission. The transmitting can include initiating a transmission of code; or causing the code to pass into any region or country from another region or country. A transmission to a user can include any transmission received by the user in any region or country, regardless of the location from which the transmission is sent.

Embodiments of the present invention can include a signal containing code which can be executed at a computer to perform any of the processes of embodiments of the present invention. The signal can be transmitted through a network, such as the Internet; through wires, the atmosphere or space; or any other type of transmission. The entire signal need not be in transit at the same time. The signal can extend in time over the period of its transfer. The signal is not to be considered as a snapshot of what is currently in transit.

The foregoing description of embodiments of the present invention has been provided for the purposes of illustration and description. It is not intended to be exhaustive or to limit the invention to the precise forms disclosed. Many modifications and variations will be apparent to one of ordinary skill in the relevant arts. For example, steps performed in the embodiments of the invention disclosed can be performed in alternate orders, certain steps can be omitted, and additional steps can be added. It is to be understood that other embodiments of the invention can be developed and fall within the spirit and scope of the invention and claims. The embodiments were chosen and described in order to best explain the principles of the invention and its practical application, thereby enabling others of ordinary skill in the relevant arts to understand the invention for various embodiments and with various modifications that are suited to the particular use contemplated. It is intended that the scope of the invention be defined by the following claims and their equivalents.

The entire disclosure of U.S. Provisional Patent Application 60/887,110 filed Jan. 29, 2007, including specification, claims, drawings, and abstract is incorporated herein by reference in its entirety.

What is claimed is:

1. A method, comprising:
at a computer system having one or more processors, memory and a touch screen:
storing information about a plurality of users, the information including rankings for the users indicating, for each respective user in the plurality of users, a variation of the user interface that is to be displayed to the respective user;
identifying a particular user as a current user of the computer system; and
displaying the variation of the user interface that is associated with the particular user on the touch screen.

2. The method of claim 1, further comprising updating the rankings for the users in accordance with user actions.

3. The method of claim 1, wherein the computer system is configured to be used by multiple different users of the plurality of users.

4. The method of claim 1, wherein:
when the variation of the user interface that is associated with the particular user is a goal-oriented user interface, displaying the variation of the user interface that is associated with the particular user includes displaying a visually simple user interface having goal-oriented information including options for performing one-step actions; and
when the variation of the user interface that is associated with the particular user is a process-oriented user interface, displaying the variation of the user interface that is associated with the particular user includes displaying a visually complex user interface having process-oriented information including options for performing multi-step actions.

5. The method of claim 4, further comprising displaying the goal-oriented information on the touch screen in a position associated with a corresponding physical device in the conference room.

6. The method of claim 1, wherein:
the user interface is for controlling one or more physical devices in a conference room;
each of the plurality of physical devices has a plurality of states; and
a current state of a respective physical device in the conference room is visually determinable from information appearing on a corresponding controller, for the respective physical device, in the user interface.

7. The method of claim 6, further comprising enabling user customization of the options for the combination of the user, the conference room, and the physical devices.

8. The method of claim 1, further comprising enabling user control of video conferences, presentations, whiteboards, and external laptops.

9. The method of claim 8, further comprising enabling user selection of video conference attendees from a list of attendees, presentations from a list of presentations, sets of notes from a list of whiteboard note sets, and laptops from a list of laptops.

10. A computer system, comprising:
one or more processors;
memory; and
one or more programs, wherein the one or more programs are stored in memory and configured to be executed by the one or more processors, the one or more programs including instructions for:
storing information about a plurality of users, the information including rankings for the users indicating, for each respective user in the plurality of users, a variation of the user interface that is to be displayed to the respective user;
identifying a particular user as a current user of the computer; and
displaying the variation of the user interface that is associated with the particular user on the touch screen.

11. The system of claim 10, further comprising instructions for updating the rankings for the users in accordance with user actions.

12. The system of claim 10, wherein the computer system is configured to be used by multiple different users of the plurality of users.

13. The system of claim 10, wherein:
when the variation of the user interface that is associated with the particular user is a goal-oriented user interface, displaying the variation of the user interface that is associated with the particular user includes displaying a visually simple user interface having goal-oriented information including options for performing one-step actions; and
when the variation of the user interface that is associated with the particular user is a process-oriented user interface, displaying the variation of the user interface that is associated with the particular user includes displaying a visually complex user interface having process-oriented information including options for performing multi-step actions.

14. The system of claim 13, further comprising instructions for displaying the goal-oriented information on the touch screen in a position associated with a corresponding physical device in the conference room.

15. A non-transitory computer readable storage medium, storing one or more programs, the one or more programs comprising instructions, which when executed by a computer system with one or more processors and memory, cause the computer system to:
store information about a plurality of users, the information including rankings for the users indicating, for each respective user in the plurality of users, a variation of the user interface that is to be displayed to the respective user;
identify a particular user as a current user of the computer; and
display the variation of the user interface that is associated with the particular user on the touch screen.

16. The computer readable storage medium of claim 15, further comprising instructions to update the rankings for the users in accordance with user actions.

17. The computer readable storage medium of claim 15, wherein the computer system is configured to be used by multiple different users of the plurality of users.

18. The computer readable storage medium of claim 15, wherein:
when the variation of the user interface that is associated with the particular user is a goal-oriented user interface, displaying the variation of the user interface that is associated with the particular user includes displaying a visually simple user interface having goal-oriented information including options for performing one-step actions; and
when the variation of the user interface that is associated with the particular user is a process-oriented user interface, displaying the variation of the user interface that is associated with the particular user includes displaying a visually complex user interface having process-oriented information including options for performing multi-step actions.

19. The computer readable storage medium of claim 18, further comprising instructions to display the goal-oriented information on the touch screen in a position associated with a corresponding physical device in the conference room.
